(19) United States
(12) Patent Application Publication
(10) Pub. No.: US 2022/0082982 A1
(43) Pub. Date: Mar. 17, 2022

(54) FOIL TRANSFER DEVICE AND IMAGE FORMING SYSTEM

(71) Applicant: CANON KABUSHIKI KAISHA, Tokyo (JP)

(72) Inventors: Takehiro Kishi, Ibaraki (JP); Yukihiro Soeta, Kanagawa (JP); Tomohito Nakagawa, Chiba (JP); Kiyoshi Watanabe, Chiba (JP); Kazuhisa Okuda, Tokyo (JP); Michiaki Endo, Chiba (JP)

(21) Appl. No.: 17/535,499

(22) Filed: Nov. 24, 2021

Related U.S. Application Data
(63) Continuation of application No. PCT/JP2020/020446, filed on May 25, 2020.

(30) Foreign Application Priority Data
May 30, 2019 (JP) 2019-101746

(51) Int. Cl. G03G 15/00

(52) U.S. Cl. CPC G03G 15/6582

(57) ABSTRACT

A foil transfer device includes a foil transfer unit configured to perform foil transfer processing of transferring a foil to a sheet with a toner image formed thereon, a first conveyance path configured to convey the sheet from a reception portion to the foil transfer unit and convey the sheet passed through the foil transfer unit to a discharge portion, and a second conveyance path configured to convey the sheet from the reception portion to the discharge portion without the sheet passing through the foil transfer unit.

### CROSS-REFERENCE TO RELATED APPLICATIONS

This application is a Continuation of International Patent Application No. PCT/JP2020/020446, filed May 25, 2020, which claims the benefit of Japanese Patent Application No. 2019-101746, filed May 30, 2019, all of which are hereby incorporated by reference herein in their entirety.

### BACKGROUND OF THE INVENTION

### Field of the Invention

The present invention relates to a foil transfer device configured to transfer a foil to a recording material with a toner image fixed thereto by heating and pressing and to an image forming system including the foil transfer device.

### Background Art

Metallic colors are difficult to reproduce by image forming using normal toners, and techniques for reproducing metallic colors using foils on outputs have been developed in recent years. In relation to this, Patent Document 1 discusses a technique in which a foil is transferred to a sheet using a toner as an adhesive.

Japanese Patent Application Laid-Open No. 2018-30316 discusses a foil transfer device including a foil film wound around a core material in the form of a roll, and the foil film is brought into contact with an entire sheet surface of a recording material with a toner image fixed thereto that is conveyed from an image forming apparatus. Then, the sheet is heated and pressed via the foil film so that the foil is transferred only to the toner image portion on the sheet.

### CITATION LIST

### Patent Literature

Patent Document 1: Japanese Patent Application Laid-Open No. 2018-30316

With the structure of the foil transfer device discussed in Japanese Patent Application Laid-Open No. 2018-30316, every sheet conveyed from the image forming apparatus is passed via a foil transfer portion of the foil transfer device. Thus, in a case where a sheet conveyed from the image forming apparatus is not to undergo foil transfer processing, the foil transfer device is to be disconnected from the image forming apparatus. Further, in a case where another sheet is to undergo foil transfer processing after the foil transfer device is disconnected from the image forming apparatus, the foil transfer device is to be re-connected to the image forming apparatus.

Since the foil transfer device is to be connected to and disconnected from the image forming apparatus based on descriptions of an image formation job for which the user intends to execute, workability has been low.

### SUMMARY OF THE INVENTION

The present invention is directed to a foil transfer device that is less likely to impair workability than conventional devices and to an image forming system including the foil transfer device.

As a representative configuration of a foil transfer device according to the present invention, a foil transfer device configured to perform foil transfer processing on a sheet with a toner image formed thereon includes a reception portion configured to receive the sheet into the foil transfer device, a discharge portion configured to discharge the sheet out of the foil transfer device, a foil transfer unit configured to perform foil transfer processing of transferring a foil to the sheet with the toner image formed thereon, a first conveyance path configured to convey the sheet from the reception portion to the foil transfer unit and convey the sheet passed through the foil transfer unit to the discharge portion, and a second conveyance path configured to convey the sheet from the reception portion to the discharge portion without the sheet passing through the foil transfer unit.

Further features of the present invention will become apparent from the following description of exemplary embodiments with reference to the attached drawings.

### BRIEF DESCRIPTION OF THE DRAWINGS

FIG. 1 is a schematic sectional view illustrating an example of an image forming system including a foil transfer device.

FIG. 2 is a sectional view illustrating a foil transfer unit.

FIG. 3 is a schematic sectional view illustrating a foil transfer device according to a second exemplary embodiment.

FIG. 4 is a schematic sectional view illustrating an example of an image forming system according to a third exemplary embodiment.

### DESCRIPTION OF THE EMBODIMENTS

### First Exemplary Embodiment

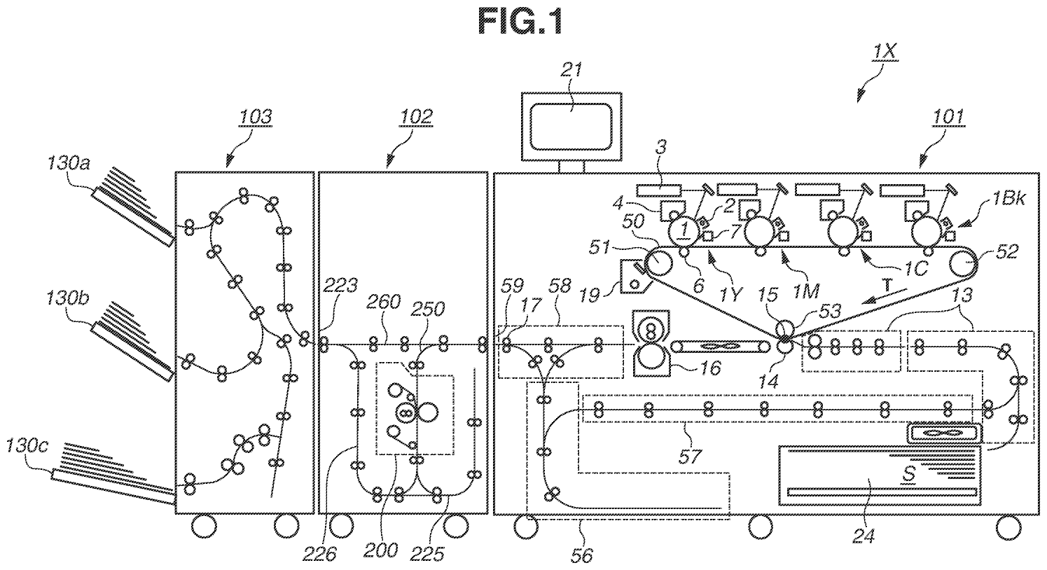

FIG. 1 is a schematic sectional view illustrating an example of an image forming system 1X in which a foil transfer device 102 according to a first exemplary embodiment of the present invention is connected between an image forming apparatus 101 and a sheet processing device 103. Initially, a structure of the image forming apparatus 101 according to the present exemplary embodiment will be described below.

### [Structure of Image Forming Apparatus]

The image forming apparatus 101 is a four-color, full-color printer using an electrophotographic process. The image forming apparatus 101 forms a toner image on a sheet S based on an image signal input to a control unit from an external device such as a personal computer (PC) and/or an external apparatus (not illustrated) such as an image reading apparatus. The sheet S is a recording medium on which a toner image can be formed, such as normal paper, thick paper, overhead projector (OHP) sheet, coated paper, or label paper.

The image forming apparatus 101 includes an operation unit 21 to receive various operations regarding the image forming apparatus 101 provided by an operator. Further, the operation unit 21 includes a display unit for displaying information and a touch panel which is operable by touching.

An image forming unit in a housing of the image forming apparatus 101 includes four imaging units 10Y, 10M, 10C, and 10K. The imaging units 10Y, 10M, 10C, and 10K respectively form yellow (Y), magenta (M), cyan (C), and black (K) toner images. These imaging mechanism units are arranged in parallel from left to right.

The imaging units 10Y, 10M, 10C, and 10K each use a toner of a different color from each other but have a similar configuration, so that an imaging unit 1Y will be described below as an example of the imaging units 10Y, 10M, 10C, and 10K. The imaging unit 1Y includes a photosensitive drum 1, a charging device 2, an exposure device 3, a development unit 4, a temporary transfer roller 6, and a drum cleaner 7. The photosensitive drum 1 is charged to a uniform potential by the charging device 2. The exposure device 3 then forms an electrostatic latent image on the photosensitive drum 1, and the development unit 4 develops the formed electrostatic latent image to form a toner image. The formed toner image is then transferred onto an intermediate transfer belt 50 by the temporary transfer roller 6. The toner that is not transferred to the intermediate transfer belt 50 is collected by the drum cleaner 7.

The intermediate transfer belt 50 is stretched around a driving roller 51, a tension roller 52, and a secondary transfer inner roller 53 and is driven in the direction of the arrow T in FIG. 1. The intermediate transfer belt 50 is rotated to sequentially transfer the toner images formed on the photosensitive members. The toner image of the respective colors from the rotating photosensitive drums 1 of the imaging units 10Y, 10M, 10C, and 10K is then superimposed and primarily transferred. Consequently, a full-color unfixed toner image of the four colors Y, M, C, and K superimposed thereon is formed on the intermediate transfer belt 50.

Meanwhile, the sheet S is singly fed from sheet storage unit 24 by a conveyance roller (not illustrated) and is conveyed via a conveyance path 13 to a secondary transfer nip portion 15 at a predetermined control timing. The secondary transfer nip portion 15 is a pressed portion of the intermediate transfer belt 50 and a secondary transfer roller 14. Thus, the toner images formed on the intermediate transfer belt 50 are secondarily transferred onto the sheet S all together. Then, the residual toner that is not transferred and remains on the intermediate transfer belt 50 after the secondary transfer of the toner images to the sheet S is removed from the surface of the intermediate transfer belt 50 by a belt cleaner 19.

Thereafter, the sheet S with the transferred toner images thereon is heated and pressed by a fixing device 16 to fix the toner images to the sheet S. The sheet S with the toner images fixed thereto by the fixing device 16 is then conveyed via a conveyance path 58 and is discharged out of the image forming apparatus 101 via a sheet discharge exit 59 by a pair of discharge rollers 17.

Further, in a case where an image is to be formed on both sides of the sheet S, the image forming apparatus 101 conveys the sheet S having a first surface with an image formed thereon via the conveyance path 58 to a reverse conveyance path 56 to reverse the first surface and a second surface of the sheet S. Thereafter, the sheet S is conveyed to a two-sided sheet conveyance path 57 and then to the secondary transfer nip portion 15 via the conveyance path 13 again so that an image is formed on the second surface of the sheet S. The sheet S with toner images formed on the second surface is caused to pass through the fixing device 16 again to fix the toner images to the sheet S. The sheet S is then conveyed via the conveyance path 58 and is discharged through the sheet discharge exit 59 by the pair of discharge rollers 17 as in the above-described one-sided image forming operation.

The sheet S discharged through the sheet discharge exit 59 of the image forming apparatus 101 is conveyed to the foil transfer device 102 connected downstream of the image forming apparatus 101.

Thereafter, in a case where the sheet S is to undergo foil transfer processing, a foil transfer unit 200 of the foil transfer device 102 performs foil transfer processing on the sheet S.

### [Structure of Foil Transfer Unit]

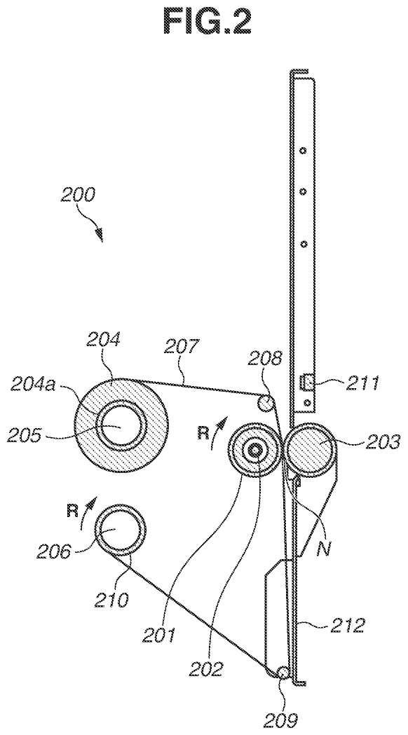

Next, a structure of the foil transfer unit 200 of the foil transfer device 102 will be described below. FIG. 2 is a schematic sectional view illustrating the foil transfer unit 200 of the foil transfer device 102 according to the present exemplary embodiment.

The foil transfer unit 200 includes a heating roller 201 serving as a heating member. The heating roller 201 includes a steel-tube-structure-machine (STKM) pipe and a silicon rubber wound around the outer periphery of the STKM pipe. The silicon rubber has a thickness of 2 mm, and the heating roller 201 has an outer of 40 mm. Further, the heating roller 201 includes a bearing (not illustrated) at each end of a rotation shaft so that the heating roller 201 is supported rotatably with respect to a housing (not illustrated) of the foil transfer unit 200. The heating roller 201 is rotated in a clockwise direction R in FIG. 2 by a driving device (not illustrated). Further, both ends of a heater 202 serving as a heat source are supported by a support member (not illustrated) in a central portion of the heating roller 201 so that the heater 202 does not come into contact with the heating roller 201.

A pressing roller 203 is situated to face the heating roller 201. The pressing roller 203 is biased to be pressed against the heating roller 201 by a bias member (not illustrated). The pressing roller 203 and the heating roller 201 form a nip N where a foil film 207 is sandwiched. At the nip N, the conveyed sheet S is conveyed while being sandwiched between the heating roller 201 and the pressing roller 203 via the foil film 207.

The pressing roller 203 includes a roller made of STKM material and a perfluoroalkoxy (PFA) tube wound around a surface of the STKM roller, as material. The heating roller 201 is supported rotatably with respect to the housing of the foil transfer unit 200 by a bearing (not illustrated). According to the present exemplary embodiment, the rotation of the pressing roller 203 is driven by the heating roller 201 via the foil film 207.

Further, a feeding roller 205 serving as a feeding member situated above the heating roller 201 is provided with a foil roller 204. The foil roller 204 includes a roller core 204a and layers of a foil film wound around the roller core 204a. As a schematic structure, the foil film 207 is a film including a 12-μm polyethylene terephthalate (PET) sheet with a release layer, a color layer, an aluminum vapor-deposited layer, and a toner bonding layer combined together. The foil film 207 is an extremely thin film having a total thickness of about 16 μm. Further, the foil film 207 has a glossy color, such as gold or silver.

The foil roller 204 and the foil film 207 are consumables and thus designed replaceably with respect to the foil transfer device 102. In attaching the foil roller 204 and the foil film 207, the foil film 207 is pulled out from the foil roller 204 being mounted on the feeding roller 205, is passed through the nip N formed by the heating roller 201 and the pressing roller 203 via a tension roller 208, is bent at a separation roller 209, and is then attached to a winding core 210 mounted in advance on a winding roller 206 serving as a winding member situated above the heating roller 201 to the left. In attaching the foil film 207, the foil film 207 is passed through the nip N in a state in which the pressing roller 203 pressed by a spring is moved in a direction away from the heating roller 201. As a result of the foregoing series of operations, the foil film 207 is attached to the foil transfer device 102.

Then, the heater 202 is turned on to heat the heating roller 201. The turning on of the heater 202 is controlled by a thermistor (not illustrated) in contact with a surface of the heating roller 201 so that the surface temperature of the heating roller 201 is uniformly maintained at 160° C. in a lengthwise direction. The heater 202 herein is turned on based on the image forming apparatus 101 having received an image formation job.

The heating roller 201 does not start rotating until the thermistor reaches a surface temperature of 160° C. and changes to a standby state. Then, in a case where the surface temperature of the heating roller 201 reaches 160° C. and the foil transfer device 102 is ready to perform foil transfer (the foil transfer device 102 is changed from a preparation state to a standby state), the foil transfer device 102 transmits information indicating that the foil transfer device 102 is ready to receive the sheet S to the image forming apparatus 101 via a control unit (not illustrated). Specifically, the foil transfer device 102 outputs a signal to notify the image forming apparatus 101 that the foil transfer device 102 is ready to perform foil transfer processing.

According to the present exemplary embodiment, driving forces of the heating roller 201 and the winding roller 206 are input from the same driving source (not illustrated), and the heating roller 201 and the winding roller 206 are rotated in the same direction (direction of an arrow R). The rotation speed of the winding roller 206 is 1.05 times the rotation speed of the heating roller 201. The arrangement of a torque limiter (not illustrated) between the winding roller 206 and the driving source winds up the foil film 207 while predetermined tension is maintained with respect to the foil film 207 between the nip N and the winding roller 206 during the winding up of the foil film 207.

The driving source does not feed driving force to the feeding roller 205, and the feeding roller 205 is rotated following the pulling out of the foil film 207 by the rotation of the heating roller 201. A torque limiter (not illustrated) is also mounted on the feeding roller 205 so that the feeding roller 205 is not rotated unless a torque greater than or equal to a set torque is applied. This enables application of uniform tension to the foil film 207 between the foil roller 204 and the nip N. Thus, the foil film 207 enters the nip N in a stretched state, so that a state where the foil film 207 is less likely to form wrinkles and sag is maintained.

While the structure in which driving forces are input to the heating roller 201 and the winding roller 206 has been described above as an example according to the present exemplary embodiment, driving forces can be input to the pressing roller 203 and the winding roller 206.

### [Structure of Image Forming System]

Next, the image forming system 1X in which the foil transfer device 102 is connected will be described below with reference to FIG. 1. As described above, the image forming system 1X includes the foil transfer device 102 connected between the image forming apparatus 101 and the sheet processing device 103. Here, the image forming apparatus 101 is merely an example of an upstream device connected upstream of the foil transfer device 102 in a sheet conveyance direction. Further, the sheet processing device 103 herein is an example of a downstream device connected downstream of the foil transfer device 102 in the sheet conveyance direction.

The sheet S on which a toner image is formed by the image forming apparatus 101 with the above-described structure is conveyed to the foil transfer device 102 so that foil transfer processing can be performed on the sheet S. The sheet S is then conveyed to the sheet processing device 103, and various types of processing can be performed on the sheet S. According to the present exemplary embodiment, the foil transfer device 102 is connected between the image forming apparatus 101 and the sheet processing device 103, so that the sheet S that is to be conveyed to the sheet processing device 103 passes through the foil transfer device 102.

A sheet reception portion 222 of the foil transfer device 102 receives the sheet S discharged from the sheet discharge exit 59 of the image forming apparatus 101, and the sheet S is discharged from a first discharge portion 223 to the sheet processing device 103. The foil transfer device 102 according to the present exemplary embodiment includes a first conveyance path 250 and a second conveyance path 260 which serve as a conveyance path for conveying the sheet S received into the foil transfer device 102 at the sheet reception portion 222 to the a portion where the sheet S is discharged out of the foil transfer device 102 through the first discharge portion 223.

The first conveyance path 250 is a conveyance path that conveys the sheet S to the foil transfer unit 200 and then to the first discharge portion 223. The second conveyance path 260 is a conveyance path that conveys the sheet S to the first discharge portion 223 without conveying the sheet S to the foil transfer unit 200.

The foil transfer device 102 acquires job information for the sheet S from the control unit (not illustrated) of the image forming apparatus 101 to acquire information about whether foil transfer processing is to be performed on the sheet S. In a case where the foil transfer processing is to be performed on the sheet S, the sheet is conveyed to the first conveyance path 250, whereas, in a case where the foil transfer processing is not to be performed on the sheet S, the sheet S is conveyed to the second conveyance path 260.

First, the image forming system 1X in a case where the foil transfer processing is to be performed on the sheet S will be described below. As described above, in a case where the image forming apparatus 101 receives an image formation job to perform the foil transfer processing on the sheet S, the heater 202 of the foil transfer unit 200 is turned on to heat the heating roller 201 to a predetermined temperature.

Then, in a case where the heating roller 201 reaches the predetermined temperature, a notification that the foil transfer device 102 is ready to perform the foil transfer processing is transmitted to the image forming apparatus 101 via the control unit (not illustrated) of the foil transfer device 102. The image forming apparatus 101 starts forming a toner image on the sheet S so that the sheet S is conveyed to the foil transfer device 102 after the foil transfer device 102 becomes ready to perform the foil transfer processing.

Thereafter, the sheet S that has received at the sheet reception portion 222 is conveyed to the first conveyance path 250 dedicated to the foil transfer where the foil transfer unit 200 is situated.

After the sheet S is conveyed to the first conveyance path 250, the conveyance of a front edge of the sheet S into the foil transfer unit 200 is detected based on the detection of the sheet S by a sheet detection sensor 211. The foil transfer unit 200 then starts rotating the heating roller 201 based on the detection result by the sheet detection sensor 211.

The rotation of the heating roller 201 pulls out the foil film 207 from the foil roller 204, and the foil film 207 is conveyed at the same peripheral speed as that of the heating roller 201. The foil film 207 is wound around the winding roller 206 at the same time with the pulling out of the foil film 207 from the foil roller 204.

When the sheet S with the toner image formed thereon arrives at the nip N and receives heat from the heating roller 201 via the foil film 207, the foil on the foil film 207 is bonded only to the toner image region by receiving pressure from the pressing roller 203. The heating by the heating roller 201 re-melts the toner image formed on the sheet S, and the re-melted toner plays a role as an adhesive to bond the foil to the sheet S.

After passing through the nip N, the sheet S is conveyed to the separation roller 209 through a region between the foil film 207 and a guide 212 situated to face the foil film 207 while being in close contact with the foil film 207. Thereafter, the separation roller 209 separates only an etching (ET) sheet of the foil film 207 so that only the foil is transferred onto the sheet S to form a foil image on the sheet S. At this time, the foil film 207 is not bonded to a region on the sheet S where no toner image is formed, so that the foil is not transferred to the region and therefore no foil image is formed on the region.

Thereafter, the sheet S with the foil transferred thereto is conveyed to the first discharge portion 223 by a plurality of pairs of conveyance rollers and discharged from the foil transfer device 102. According to the present exemplary embodiment, the sheet S is discharged from the foil transfer device 102 to the sheet processing device 103.

In a case where the sheet S is to be reversed and discharged with the front surface facing downward (the sheet S is to be discharged with the foil-transferred surface facing downward), the sheet S is conveyed to a reversing portion 225 situated downstream of the foil transfer unit 200 in the sheet conveyance direction. Thereafter, the sheet S is conveyed to be reversed using a switching member (not illustrated) so that the front edge and a back edge of the sheet S are switched-back. The sheet S with the switched-back edges is conveyed to a first discharge conveyance path 226 with the foil-transferred surface facing downward and then conveyed to the first discharge portion 223. Consequently, the sheet S is discharged from the foil transfer device 102 with the foil-transferred surface facing downward, so that confidentiality of the deliverable in the discharged state is secured. Further, since the sheet S is discharged with the foil-transferred surface (image-formed surface) facing downward, the deliverable is obtained without rearranging the page order. In a case where the sheet S does not have to be discharged with the front surface facing downward, the sheet S can be discharged without being reversed.

Next, a case where the foil transfer processing is not to be performed on the sheet S will be described below. In a case where an image formation job to form a toner image on the sheet S but to not perform the foil transfer processing is received, the sheet S conveyed to the sheet reception portion 222 of the foil transfer device 102 is conveyed to the second conveyance path 260, which does not pass through the foil transfer unit 200.

The sheet S conveyed to the second conveyance path 260 is directly discharged from the foil transfer device 102 through the first discharge portion 223. The sheet S on which the foil transfer processing is not to be performed is conveyed from the conveyance path 58 to the reverse conveyance path 56 before being discharged from the image forming apparatus 101 so that the first surface and the second surface (the back side of the first surface) are reversed and the sheet S is discharged with the image-formed surface facing downward as described above. In a case where the sheet S does not have to be discharged with the front surface facing downward, the sheet S can be discharged directly without being reversed.

The sheet S that has been conveyed to the first conveyance path 250 or the second conveyance path 260 of the foil transfer device 102 and discharged from the first discharge portion 223 is then conveyed to the sheet processing device 103 connected downstream of the foil transfer device 102 in the sheet conveyance direction.

The sheet processing device 103 includes a bookbinding processing unit (not illustrated) that performs bookbinding processing on the sheet S and a punching unit (not illustrated) that performs punching processing on the sheet S. Thus, the sheet processing device 103 can perform various types of processing, such as bookbinding processing, punching processing, and sorting processing.

The sheet S conveyed to the sheet processing device 103 undergoes processing and is then discharged to one of discharge trays 130a, 130b, and 130c. Alternatively, the sheet processing device 103 can discharge the sheet S directly to one of the discharge trays 130a, 130b, and 130c without performing any processing described above.

While the image forming system 1X in which the sheet processing device 103 is connected has been described in the present exemplary embodiment, in a case where the sheet processing device 103 is not connected to the foil transfer device 102, the foil transfer device 102 can include a sheet stacking unit (not illustrated) for stacking sheets discharged from the first discharge portion 223 so that the sheet S is discharged to the sheet stacking unit.

As described above, the foil transfer device 102 according to the present exemplary embodiment includes the first conveyance path 250, which passes through the foil transfer unit 200, and the second conveyance path 260, which does not pass through the foil transfer unit 200. With this structure, the sheet S on which foil transfer processing is not to be performed does not pass through the foil transfer unit 200. Thus, even in a state where the foil transfer device 102 is connected to the image forming apparatus 101, the sheet S on which the foil transfer processing is not to be performed is prevented from undergoing foil transfer processing.

Further, in a case where the image forming system 1X is to perform image forming processing or sheet post-processing on the sheet S on which foil transfer processing is not to be performed, the foil transfer device 102 does not have to be removed from the image forming system 1X. Specifically, the foil transfer device 102 does not have to be disconnected from the image forming apparatus 101 based on an image formation job for which the user intends to execute, so that workability improves.

Further, in a case where the sheet S that has been conveyed from the image forming apparatus 101 is not to undergo foil transfer processing, since the sheet S does not have to be conveyed through the foil transfer unit 200, the foil transfer unit 200 does not have to include the separation mechanism for separating the heating roller 201 and the pressing roller 203 from each other. This prevents a decrease in productivity due to separation of the heating roller 201 and the pressing roller 203 or a switching operation for the pressing of the heating roller 201 and the pressing roller 203 against each other in a case where the sheet S that is to undergo the foil transfer processing and the sheet S that is not to undergo the foil transfer processing are consecutively conveyed.

### Second Exemplary Embodiment

According to the first exemplary embodiment described above, the first conveyance path 250 passing through the foil transfer unit 200 is situated below the second conveyance path 260. This is not a limiting structure, and any structure including a conveyance path that passes through the foil transfer unit 200 and a conveyance path that does not pass through the foil transfer unit 200 can be employed.

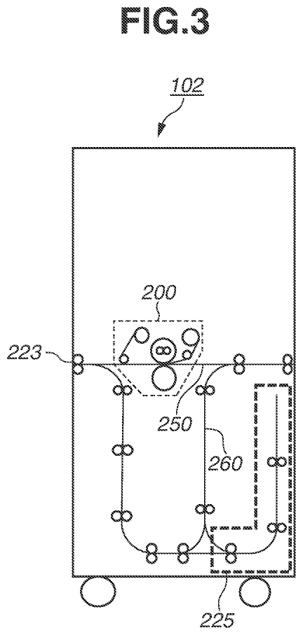

Next, the foil transfer device 102 according to a second exemplary embodiment will be described below with reference to FIG. 3. According to the present exemplary embodiment, the first conveyance path 250 is situated above the second conveyance path 260. Specifically, according to the present exemplary embodiment, the sheet S on which the foil transfer processing is not to be performed is conveyed via the second conveyance path 260 situated below the foil transfer unit 200 and is discharged from the first discharge portion 223. With this structure, the sheet S on which the foil transfer processing is not to be performed does not pass through the foil transfer unit 200. Thus, even in a state where the foil transfer device 102 is connected to the image forming apparatus 101, the sheet S on which the foil transfer processing is not to be performed is prevented from undergoing the foil transfer processing.

Further, in a case where the image forming system 1X is to perform image forming processing or sheet post-processing on the sheet S on which the foil transfer processing is not to be performed, the foil transfer device 102 does not have to be removed from the image forming system 1X. In other words, such a configuration eliminates the need to disconnect the foil transfer device 102 from the image forming apparatus 101 based on an image formation job for which the user intends to execute, so that workability improves.

Further, in a case where the sheet S that has been conveyed from the image forming apparatus 101 is not to undergo the foil transfer processing, since the sheet S does not have to be conveyed through the foil transfer unit 200, the foil transfer unit 200 does not have to include the separation mechanism for separating the heating roller 201 and the pressing roller 203 from each other. Further, the first conveyance path 250 and the second conveyance path 260 are provided so that a decrease in productivity due to separation of the heating roller 201 and the pressing roller 203 or a switching operation for the pressing of the heating roller 201 and the pressing roller 203 against each other in a case where the sheet S that is to undergo foil transfer processing and the sheet S that is not to undergo foil transfer processing are consecutively conveyed is prevented.

In a case where the user of the image forming system 1X executes an image formation job of forming a normal toner image more frequently than an image formation job involving the foil transfer processing on the sheet S, the second conveyance path 260 is desirably shorter in length than the first conveyance path 250 as in the first exemplary embodiment. With this structure, the output time of the first output of an image formation job of forming only a toner image on the sheet S on which the foil transfer processing is not to be performed is expedited.

On the contrary, in a case where the user executes an image formation job involving the foil transfer processing on the sheet S more frequently than an image formation job of forming a normal toner image, the second conveyance path 260 is desirably shorter in length than the first conveyance path 250 as in the second exemplary embodiment. With this structure, the output time of the first output of an image formation job involving the foil transfer processing is expedited.

### Third Exemplary Embodiment

### [Structure for Foil Stamping and Overprinting]

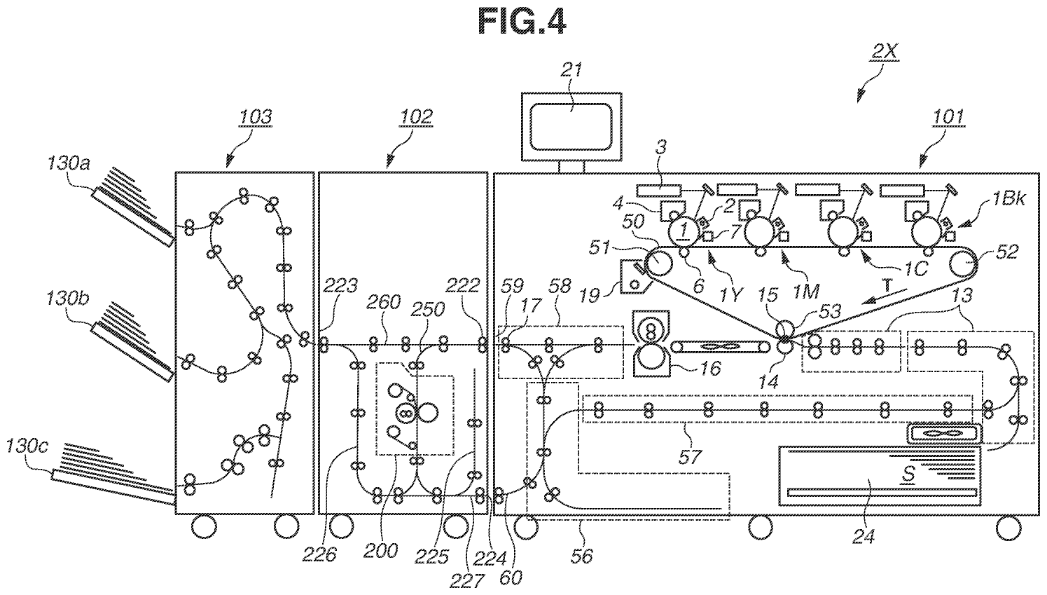

FIG. 4 illustrates a structure of an image forming system 2X according to a third exemplary embodiment. According to the present exemplary embodiment, a normal toner image can be formed together with a glossy foil image through foil transfer processing and, furthermore, a toner image can be formed and superimposed on a foil image. Thus, according to the present exemplary embodiment, a second discharge portion 224 is provided to discharge a sheet from the foil transfer device 102 to the image forming apparatus 101. Each component according to the present exemplary embodiment which is similar to the corresponding component according to the first exemplary embodiment is given the same reference numeral, and redundant descriptions thereof are omitted.

Further, the foil transfer processing on the sheet S with a toner image formed thereon according to the third exemplary embodiment is similar to that according to the first exemplary embodiment, so that redundant descriptions thereof are omitted. The sheet S on which foil the transfer processing is performed and a foil image is formed is conveyed from the foil transfer unit 200 to a second discharge conveyance path 227 and conveyed to the second discharge portion 224.

The sheet S that has been conveyed to the second discharge portion 224 is conveyed from the foil transfer device 102 to a re-conveyance path 60 of the image forming apparatus 101. The sheet S that has been conveyed to the image forming apparatus 101 again is then conveyed to the conveyance path 13 again via part of the reverse conveyance path 56 and the two-sided sheet conveyance path 57.

Thereafter, the sheet S is conveyed to the secondary transfer nip portion 15 again in a state where the surface that has the formed foil image thereon faces the secondary transfer inner roller 53 at the secondary transfer nip portion 15. The sheet S with a toner image formed and superimposed on the foil image at the secondary transfer nip portion 15 is conveyed to the fixing device 16 to fix the toner image onto the foil image. This makes it possible to form a toner image again on the surface of the sheet S on which a foil image is formed.

A glossy, metallic-color image is formable through superimposition of a toner image on a foil image as described above. In forming multiple layers of toner images on a top surface of a foil image, various types of gloss, brightness, and tints are expressible using different toner densities and colors. In other words, it is possible to output images with higher foil glossiness for lower densities, and glossy images with higher enhanced colors for higher densities. Further, various colors can be reproduced using different combinations of foil colors. Moreover, various colors can also be reproduced using different pattern shapes of toner images.

The sheet S with the toner image formed and superimposed on the foil image as described above is then conveyed via the conveyance path 58 and discharged from the image forming apparatus 101 through the sheet discharge exit 59 by the pair of discharge rollers 17. The sheet S is conveyed to the foil transfer device 102 again and conveyed via the second conveyance path 260 to the first discharge portion 223 without passing through the foil transfer unit 200 and then to the sheet processing device 103 connected downstream.

The foil transfer processing is also performable on a second surface that is the back side of the sheet S having a first surface on which an image including a foil transfer image has been formed through the above-described process. For example, after image forming processing is performed on the first surface, the sheet S is reversed by the reverse conveyance path 56 of the image forming apparatus 101, and the reversed sheet S is conveyed to the two-sided sheet conveyance path 57. Thereafter, the sheet S is conveyed to the secondary transfer nip portion 15 again with the second surface facing the secondary transfer inner roller 53 at the secondary transfer nip portion 15. The sheet S with the toner image transferred to the second surface is then conveyed to the fixing device 16 and heated and pressed at the same time to fix the toner image to the second surface of the sheet S. After having passed through the fixing device 16, the sheet S is discharged from the sheet discharge exit 59 by the pair of discharge rollers 17 and is conveyed to the foil transfer device 102.

In the present exemplary embodiment, in order to perform the foil transfer processing also on the second surface, the sheet S is conveyed to the first conveyance path 250 of the foil transfer device 102. Thereafter, the foil transfer unit 200 transfers the foil of the foil film 207 to the region where the toner image is formed as on the first surface.

The sheet S that has been subjected to the foil transfer processing on the second surface is conveyed via the first discharge conveyance path 226 to the first discharge portion 223 and is discharged from the foil transfer device 102.

Further, in a case where a toner image is to be superimposed on the foil image on the second surface as on the first surface, after the sheet S has passed through the foil transfer unit 200 via the first conveyance path 250 and thereafter via the second discharge conveyance path 227, the sheet S is then conveyed from the second discharge portion 224 to the re-conveyance path 60 of the image forming apparatus 101.

The sheet S that has been then conveyed to the re-conveyance path 60 is conveyed via part of the reverse conveyance path 56 and the two-sided sheet conveyance path 57 again to the conveyance path 13 as in the image forming operation performed on the first surface described above. A toner image is then transferred to be superimposed on the foil image at the secondary transfer nip portion 15, and the fixing device 16 fixes the toner image onto the foil image to form a metallic color image also on the second surface of the sheet S.

The sheet S with the metallic color images formed on the both surfaces passes through the conveyance path 58 and is then conveyed from the sheet discharge exit 59 to the foil transfer device 102 by the pair of discharge rollers 17. Thereafter, the sheet S is conveyed to the second conveyance path 260 so that the sheet S is conveyed to the first discharge portion 223 without passing through the foil transfer unit 200, and then the sheet S is conveyed to the sheet processing device 103 connected downstream of the foil transfer device 102. In a case where predetermined processing such as stapling processing is to be performed on the sheet S, the sheet processing device 103 performs various types of processing on the sheet S and thereafter discharges the sheet S to one of the discharge trays 130a, 130b, and 130c. Further, in a case where processing is not to be performed on the sheet S, the sheet S is directly discharged to one of the discharge trays 130a, 130b, and 130c.

According to the present exemplary embodiment, the first conveyance path including the foil transfer unit 200 and the second conveyance path not including the foil transfer unit 200 are provided so that the sheet S on which the foil transfer processing is not to be performed is conveyed without passing through the foil transfer unit 200. Thus, even in a state where the foil transfer device 102 is connected to the image forming apparatus 101, the sheet S on which the foil transfer processing is not to be performed is prevented from undergoing the foil transfer processing.

Further, in a case where the image forming system 1X is to perform image forming processing or sheet post-processing on the sheet S on which the foil transfer processing is not to be performed, the foil transfer device 102 does not have to be removed from the image forming system 1X. In other words, such a configuration eliminates the need to disconnect the foil transfer device 102 from the image forming apparatus 101 based on an image formation job for which the user intends to execute, so that workability improves.

Further, in a case where the sheet S that has been conveyed from the image forming apparatus 101 is not to undergo the foil transfer processing, since the sheet S does not have to pass through the foil transfer unit 200, the foil transfer unit 200 does not have to include the separation mechanism for separating the heating roller 201 and the pressing roller 203 from each other. Further, the first conveyance path 250 and the second conveyance path 260 are provided so that a decrease in productivity due to separating of the heating roller 201 and the pressing roller 203 or a switching operation for pressing of the heating roller 201 and the pressing roller 203 against each other in a case where the sheet S that is to undergo the foil transfer processing and the sheet S that is not to undergo the foil transfer processing are consecutively conveyed is prevented.

### OTHER EXEMPLARY EMBODIMENTS

While the image forming apparatus 101 forms an image on the sheet S after the foil transfer device 102 changes to the standby state in the above-described exemplary embodiments, the image forming operation may be started before the foil transfer device 102 changes to the standby state. For example, the image forming operation may be started so that the sheet S is conveyed to the foil transfer unit 200 at a timing when the foil transfer device 102 changes to the standby state.

Further, while the heater 202 of the foil transfer unit 200 is turned on in every case where an image formation job is received in the above-described exemplary embodiments, the heater 202 can be not turned on in a case where the received image formation job does not involve the foil transfer processing. In other words, the heater 202 can be turned on based on the description of the received image formation job. With this structure, the foil transfer device 102 only drives the second conveyance path 260 in a case where an image formation job involving only toner image formation on the sheet S is received, thus reducing power consumption.

Further, while the second conveyance path 260 of the foil transfer device 102 is a conveyance path dedicated to conveyance in the above-described exemplary embodiments, a processing unit other than the foil transfer unit 200 can be included. For example, other processing units configured to perform creasing (streaking) processing may be included.

Further, while the foil transfer device 102 is directly connected to the image forming apparatus 101 in the above-described exemplary embodiments, another sheet processing device may be connected between the image forming apparatus 101 and the foil transfer device 102. Even with this structure, the foil transfer unit 200 re-melts a toner image on the sheet S and transfers the foil onto the toner image. In a case where the sheet S is to be conveyed from the foil transfer device 102 to the image forming apparatus 101 again as in the third exemplary embodiment, image forming processing on the sheet S is performable most efficiently with the structure in which the foil transfer device 102 is directly connected to the image forming apparatus 101 to decrease the distance of re-conveyance to the image forming apparatus 101.

The present invention is not limited to the above-described exemplary embodiments, and various changes and modifications can be made without departing from the spirit and scope of the present invention. The following claims are attached to state the scope of the present invention.

The present invention provides a foil transfer device configured to transfer a foil to a sheet without a decrease in productivity with respect to a sheet that is not to undergo the foil transfer processing, and provides an image forming system including the foil transfer device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A foil transfer device configured to perform foil transfer processing on a sheet with a toner image formed on the sheet, the foil transfer device comprising:
a reception portion configured to receive the sheet into the foil transfer device;
a discharge portion configured to discharge the sheet out of the foil transfer device;
a foil transfer unit configured to perform foil transfer processing of transferring a foil to the sheet with the toner image formed on the sheet;
a first conveyance path configured to convey the sheet from the reception portion to the foil transfer unit and convey the sheet passed through the foil transfer unit to the discharge portion; and
a second conveyance path configured to convey the sheet from the reception portion to the discharge portion without the sheet passing through the foil transfer unit.

2. The foil transfer device according to claim 1, further comprising, in the first conveyance path, a reversing portion configured to reverse the sheet passed through the foil transfer unit and convey the reversed sheet.

3. The foil transfer device according to claim 1, wherein the discharge portion is a first discharge portion configured to discharge the sheet to a downstream device connected downstream of the foil transfer device in a sheet conveyance direction, the foil transfer device further comprising a second discharge portion configured to discharge the sheet to an upstream device connected upstream of the foil transfer device in the sheet conveyance direction.

4. The foil transfer device according to claim 1, wherein the foil transfer unit includes:
a feeding portion configured to feed a foil film,
a winding portion configured to wind the foil film forwarded from a forwarding roller,
a heating roller configured to be heated by a heating source, and
a pressing roller configured to sandwich, together with the heating roller, the foil film forwarded from the forwarding roller and to press against the heating roller via the foil film.

5. The foil transfer device according to claim 1, wherein the second conveyance path is shorter than the first conveyance path.

6. An image forming system comprising:
an image forming apparatus configured to form a toner image on a sheet; and
the foil transfer device according to claim 1 connected downstream of the image forming apparatus in a sheet conveyance direction.

7. The image forming system according to claim 6, wherein the foil transfer device includes a sheet stacking unit on which the sheet discharged from the discharge portion is stacked.

8. The image forming system according to claim 6, further comprising a sheet processing device connected downstream of the foil transfer device in the sheet conveyance direction and configured to perform predetermined processing on the sheet.
